(19) United States
(12) Patent Application Publication
(10) Pub. No.: US 2009/0257702 A1
(43) Pub. Date: Oct. 15, 2009

(54) SHAFT WITH ROLLER BEARING

(75) Inventor: Peter SOLFRANK, FRENSDORF (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, HERZOGENAURACH (DE)

(21) Appl. No.: 12/421,998

(22) Filed: Apr. 10, 2009

(30) Foreign Application Priority Data
Apr. 12, 2008 (DE) 10 2008 018 545.0

(51) Int. Cl. F16C 43/04; B21D 53/10

(52) U.S. Cl. 384/585; 29/898.041

(57) ABSTRACT

The invention relates to a shaft with a roller bearing. The roller bearing has an inner ring with an outer surface for rolling elements to roll on. According to the invention, the inner ring of the roller bearing is embedded, at least partially, into the shaft, which has been produced using primary forming methods, and the outer surface of the inner ring is exposed, at least in a part, in the axial direction and over its entire circumference.

### SCOPE OF THE INVENTION

The invention relates to a shaft with roller bearing in accordance with the preamble of Claim 1.

The expansion of a gas in a cylinder exerts work on a piston and which is transmitted to the crankshaft by means of a connecting rod. The oscillating movement of the piston is converted into a rotating movement in this way. As a consequence of the reciprocating movement of the piston and connecting rod and as a consequence of the irregular transmission behavior of the crank mechanism, inertia forces occur that are supported in motor bearings and induce vibrations in adjacent structures. The inertia forces of the linearly displaced parts of the crank mechanism, that is the oscillating masses, can be represented approximately by means of a formula based on a series expansion, in which inertia forces of first and second order are defined. Theoretically, not only first and second orders occur but an infinite number of orders that are, however, insignificant from the third order in the majority of cases on account of their small size.

The rotating masses of the crank mechanism can be balanced by counterweights on the crankshaft.

Oscillating inertia forces of the first and second order can be avoided or reduced in the case of multicylinder engines by arranging the cylinders in a skillful manner. Balance shafts are often used for in-line engines with less than 6 cylinders and V-type engines with less than 8 cylinders. In order to balance inertia forces of the second order, at least 6 cylinders are required for an in-line engine or 8 cylinders for a V-type engine, or balance shafts on which corresponding counterweights rotate at double the crankshaft speed.

Balance shafts, therefore, are used to reduce or eliminate the free inertia forces of a reciprocating piston engine in order to reduce operating noise and vibrations. The counterweights or eccentric weights mounted on the balance shaft oppose the inertia forces generated by the crank mechanism. The balance shafts are driven synchronously by the crankshaft by means of gear wheels, chains or toothed belts. One or two balance shafts are used in the majority of cases depending on the engine design.

The design of balance shafts is based on the common principles of creating a mass arrangement between bearing points outside the axis of rotation, said mass arrangement providing the imbalance. Balance shafts that are provided with partial bearings or those where the roller bearing rolls directly on the balance shaft are also known.

In order to provide shafts with a roller bearing raceway, they must either be produced completely from roll-resistant steel or must include a roll-resistant inner ring. Where roll-resistant steel, which is expensive to purchase, is used there is an additional disadvantage that, for shaping, said steel has to be rolled or forged at high temperatures using expensive tools and then at least the region on which the rolling elements will subsequently roll has to be heat-treated and machined. Where a roll-resistant inner ring is used on a shaft, the shaft material can certainly be selected within wide boundaries but the region of the shaft against which the inner ring of the roller bearing abuts has to be machined such that said region forms an interference fit with the inner ring. Therefore precise machining of both the inner surface of the inner ring and also the bearing seat on the shaft is necessary. As the interference fit works with radial pressing forces, a partial bearing is eliminated, as a roller bearing inner ring in the form of a sector or segment is not capable of producing the required radial pressing forces because of the lack of internal stress.

DE 10 2007 009 800 A, for example, shows a balance shaft for a multiple cylinder engine with a counterweight section and a bearing point, the bearing point having a radial bearing surface that extends only partially over a periphery of the bearing point. If the bearing point is not sufficient for the long service life of a roller bearing, a raceway is provided at the bearing point, said raceway being positively bonded to the bearing point by means of soldering or welding.

It is the object of the invention to develop a shaft with roller bearing arrangement such that the selection of material for the shaft can be within wide boundaries, that the precise machining of the inner surface of the roller bearing inner ring and of the bearing seat on the shaft is omitted at least on one of the two elements and that partial bearing arrangements can also be used. In addition, the production expenditure is to be reduced with no loss of quality compared with previous production methods.

The object of the invention is achieved through the object of the respective independent claims. Of the primary forming techniques possible for the creation of workpieces, the casting method with all its variants or the sintering method are usually used for the shaft. Consequently, all materials that are sinterable and/or castable can be used to produce the shaft. The embedding of an inner ring into the shaft offers the advantage of it being possible for said inner ring to be produced from a completely different material to the shaft itself. Embedding the inner ring into the shaft produces axial as well as radial securement. This securement produces a positive-locking interconnection between shaft and inner ring. This interconnection can only be separated by destroying one of the two parts.

The shaft can certainly embed the entire inner ring but in this case portions are also sufficient. It would also be possible, for example, to accommodate the inner ring by means of spokes distributed over the circumference of the shaft. The spokes at the end facing the inner ring would encompass the inner ring in a U-shaped manner to the effect that the spoke would grip the inner surface and both side surfaces of the inner ring. It is also not necessary in this case for the shaft to be situated in the center of the inner ring, it can also be formed eccentrically relative to the inner ring. The inner ring can also, for example, be embedded into the shaft only in sectors or segments.

The shaft can also be developed such that in a partial region in the radial direction the shaft extends further than the outer surface of the inner ring.

In a preferred development of the invention, the roller bearing also includes a roller bearing cage, which can be threaded over one end of the shaft as far as over the inner ring. Thus, from one end of the shaft, an outer ring of the roller bearing and a roller bearing cage can be moved over the inner ring. This possibility is used, for example, to introduce a shaft with inner ring into a roller bearing outer ring with assembled rolling elements that is pre-assembled in a housing, for example an engine block, in such a manner that the inner ring abuts against the roller bearing outer ring. The end of the shaft is realized such that the shaft with inner ring can be threaded in an optimum manner and none of the components, more especially none of the roller bearing components are damaged.

In a preferred development of the invention, the inner ring is embedded into the shaft in an angular range that is greater than 180°, but less than 360°. Consequently, one or more hollow spaces can be provided between the shaft and the inner ring. Naturally, this development makes it possible for the region in which the inner ring is embedded into the shaft to be contiguous. Consequently, imbalances can be generated, for example, in a targeted manner in the bearing region. By embedding the inner ring in an angular range that is greater than 180°, the inner ring is secured in such a manner that the inner ring cannot be displaced in the radial direction relative to the shaft. In addition, a positive-locking connection is created between shaft and inner ring and, consequently, a permanent connection.

In another preferred development of the invention, a portion of the inner ring is embedded into the shaft over the entire width of the inner surface. Thus it is possible, for example, to concentrate material from which the shaft is made on one side of the inner ring. If this region is not sufficient for the positive connection because the angle at which the inner ring is embedded into the shaft is smaller than 180°, support pieces or spokes, which are integrally formed on the shaft, can be drawn up along the inner ring until a positive-locking connection between shaft and inner ring is realized. These support pieces or spokes do not have to run over the entire width of the inner surface of the inner ring. These support pieces or spokes, when viewed in the axial direction of the inner ring, can also engage the inner ring offset from the center.

In an advantageous manner, a portion of the outer surface of the inner ring is embedded into the shaft. This means that the inner ring is surrounded by the shaft in a portion at least at one end. This provides a possibility of increasing the positive locking between shaft and inner ring. Also known are roller bearings with roller bearing cages that, on the one hand, are slotted and, on the other hand, are made from such plastics material that said roller bearing cages can be bent open so far that they can be pushed directly over the inner ring. The corresponding roller bearing outer rings are divided and consequently comprise two half shells. As a consequence of this roller bearing form, the inner ring, on the one hand, can be embedded into the shaft such that the shaft encloses the edge regions of the outer surface of the inner ring completely on both sides. Consequently, the extension of the shaft in the radial direction over the entire circumference is greater than the extension of the outer surface of the inner ring. On the other hand, because of this roller bearing form, the height by which the surface of the shaft protrudes beyond the outer surface of the inner ring is not, in principle, subject to any limit.

In a preferred embodiment of the invention, the roller bearing also includes a thrust washer, a portion of the thrust washer being embedded into the shaft to the side of the inner ring. The embedding of one or two thrust washers makes it possible to use roller bearings that have inner rings that have to be guided on one side or on both sides in an axial manner relative to the rolling elements. These thrust washers can also be used with shafts where the shaft extends in a partial region in the radial direction further than the outer surface of the inner ring and consequently forms a shoulder. The outside of the thrust washer remote from the inner ring borders in a portion on this shoulder of the shaft. The thrust washers are responsible in operation for ensuring that the rolling elements, which are rotatably connected to a rolling element cage and rotate relative to the inner ring, are positioned precisely over the inner ring. In this case, it is insignificant whether the rolling element cage or the rolling elements are guided by the thrust washers.

Said thrust washers can also be used for shafts where the entire extension region of the shaft in the radial direction is smaller than the extension region of the outer surface of the inner ring.

In an expedient manner, the inside diameter of the thrust washer is not smaller than the inside diameter of the inner ring. This avoids constriction of the shaft in the region of the thrust washer and the consequently resultant weakening of the shaft relative to forces applied to it. In this case, these are predominantly torsional forces, but bending forces also affect the shaft.

In another preferred embodiment of the invention, the thrust washer is in the form of a sector, which encloses an angle that is greater than the load area of the roller bearing in the radial direction. Particularly with shafts that are to generate imbalance, it is undesirable to impinge upon the side situated radially opposite the imbalance with weight. In order to balance out this weight again, possibly the same weight has to be supplied to the imbalance side. The embedding of the thrust washer into the shaft results, in this case too, as in the case of the inner ring, in a positive locking and permanent connection between shaft and thrust washer. As the imbalance can be generated in a sector that is smaller than 180°, the thrust washer sector is also formed, where possible, smaller than 180°. If the thrust washer falls below an angle of 180°, design measures, for example undercutting, must ensure that the thrust washer cannot become detached from the shaft.

In an advantageous manner, one of the two end portions of the thrust washer produced by the sector shape is realized as insertion inclination. The said insertion inclination on the thrust washer guarantees a smooth introduction into a central position over the inner ring of rolling elements or their rolling element cages, possibly exhibiting a small amount of play in the axial direction. In addition, the wedge-shaped gap created by the insertion inclination between rolling element or rolling element cage and thrust washer enables the build-up of a good lubricant film. If the shaft only has one direction of rotation in operation, it can be sufficient to form only one edge region of the thrust washer as insertion inclination. Appropriately, the end portion opposing the direction of rotation is used for this purpose.

In an expedient manner, the inner surface and/or a side surface of the inner ring is structured. On the one hand, the application of a structure increases the surface of the inner ring and consequently the connecting surface to the shaft. On the other hand, the positive locking of the shaft to the inner ring is improved by means of macroscopic indentations. The structure does not have to have a regular pattern. A roughness generated by sand blasting, for example, can be sufficient for the structure desired in this case. Depending on the production method, it may be expedient to structure only those portions that get embedded into the shaft. Structures may also be applied on portions of the outer surface of the inner ring, which are subsequently embedded into the shaft. This implementation can also be used for the thrust washers.

In a preferred embodiment of the invention, the inner ring includes a passage. Said passage, if it is embedded into the shaft, can increase the positive locking of the shaft to the inner ring even further. The passage, however, can only be present in the region of the inner ring that is not embedded into the shaft. Lubricant, preferably oil mist, can pass through this opening from the inside of the inner ring to the outer surface by means of centrifugal force. The shape of the opening can be optimized for supplying the lubricant. For example, the central axis of the opening, when seen in the viewing direction of the axis of rotation of the inner ring, can be in the form of a section of an ellipse or of an evolvent. With the opening developed in this manner, however, the optimum lubricant supply emerges only in one direction of rotation of the shaft.

In another preferred development of the invention, the passage is in the form of a radial bore. Radial bores are simple to produce and are consequently very inexpensive. Although it is true that supplying lubricant through a radial bore is not as optimal as can be obtained in the case of a development according to the description in the previous paragraph, however, an inner ring with a radial bore has no preferred direction of rotation. Consequently, the danger of embedding the inner ring into the shaft in the wrong direction can be avoided.

In another advantageous development of the invention, the passage extends centrally in the axial direction in the inner ring. By way of the central arrangement of the passage, the inner ring can be embedded into the shaft in an arbitrary manner as there is no preferential direction in which the inner ring has to be orientated relative to the shaft. In addition, the central arrangement of the passage guarantees a uniform distribution of lubricant to the edges of the outer surface of the inner ring.

The inner ring has a width and a circumference, wherein in an advantageous manner the width changes along the circumference. Precisely when forces act on the shaft in the radial direction on one side and rotate with it—as is the case, for example, with balance or imbalance shafts—the inner ring embedded in the shaft is loaded more in the region of the imbalance than in the region situated diametrally opposite. As the stability under load of a bearing precisely when needle bearings are used also depends on the width of the inner ring, the width of the inner ring can consequently be adapted to the load actually occurring. This means that it is possible to design the inner ring with a narrower width compared to the region in which the load occurs and thereby save weight. Precisely this weight saving is a decisive advantage for balance or imbalance shafts.

If a portion of the shaft extends in the radial direction further than the outer surface of the inner ring, the inner ring has a constant width in this portion. If a thrust washer sector is embedded into the shaft adjacent to the inner ring, the width of the inner ring remains constant along the thrust washer sector in this case too.

A weight saving can also be achieved if, instead of reducing the width of the inner ring, the thickness of the inner ring is reduced, for example. This can also be achieved, for example, in that the inner surface and the outer surface of the inner ring are each defined by an even circular cylinder, the central axes of which, although parallel, are spaced apart by a predetermined distance. The inner ring is embedded into the shaft in such a manner that the inner ring has the greatest thickness at the location with the highest load, said thickness continuously reducing over a semi-circle up to the location with the lowest load. Naturally, it is also possible to have a combination between this development and the reduction in width.

The inner ring is preferably shaped in the form of an inner ring sector. This solution can only be applied to a shaft where one side of the inner ring is totally unloaded in operation. This occurs preferably in the case of imbalance or balance shafts. The sector without the inner ring is situated at the side situated opposite the imbalance. Naturally, the thickness of the inner ring can be continuously reduced relative to the inner ring sector edges if additional weight savings need to be made.

In another advantageous embodiment of the invention, the inner ring sector encloses an angle that is greater than 180°. This development guarantees that when the shaft—preferably an imbalance shaft or a balance shaft—remains still, the inner ring remains connected to the outer ring by means of the rolling elements. With an enclosed angle of less than 180°, the inner ring sector can be lifted from the roller bearings. This can result in damage to the roller bearing when the shaft starts up.

In an expedient manner, the inner ring is produced from roller bearing steel. Consequently, the inner ring can be realized as a roller bearing inner ring. This means that the inner ring can be machined, heat-treated and polished. Consequently, it is possible to create the contour at the outer surface of the inner ring necessary to accommodate the corresponding rolling element. A hardness equivalent to the rolling elements and the outer ring of the roller bearing can be created by means of the heat treatment. This guarantees that the bearing has a long service life.

In an advantageous manner, the shaft is in the form of a balance shaft. The advantages referred to can be utilized precisely with a balance shaft or an imbalance shaft. Thus such a shaft, for example, can be mounted by means of needle bearings, the bearing points being situated in the region of the imbalances. It is also possible to utilize one bearing point as a fixed bearing and the other as a loose bearing, whereas with the loose bearing arrangement the shaft with inner ring is not guided in the axial direction relative to the outer ring. A thrust washer can also serve as securement in the axial direction in the case of the fixed bearing arrangement.

In another advantageous manner, the balance shaft can be used in a reciprocating piston engine. Reciprocating piston engines with few cylinders, especially the most common four-cylinder in-line engines, vibrate on account of inertia forces of the second order. By means of two balance shafts running at double speed parallel to the crankshaft and rotating in opposing directions with respect to one another, the vibration of the reciprocating piston engine can be reduced, as can be seen in practice in the Lanchester balance system. A balance shaft is also used in the increasingly produced six-cylinder V-type engines in order to eliminate vibrations occurring due to the design.

According to the invention, the inner ring is inserted into the primary forming tool of the shaft that is to be produced by means of primary forming techniques in such a manner that the inner ring is at least partially embedded and the outer surface of the inner ring is exposed in the axial direction in a portion and over its entire circumference.

In another specific embodiment of the invention, the shaft also has a thrust washer and a portion of the thrust washer is embedded into the shaft to the side of the inner ring.

In a preferred development of the invention, the outside of the inner ring is machined, heat-treated and finished. The inner ring is inserted into the primary forming tool as a prefabricated even circular hollow cylinder, where the inner surface of the inner ring is possibly structured to increase the surface. Once the shaft with the inner ring embedded therein has been prepared, the outer surface of the inner ring is machined to its approximate outer contour, the inner ring is then hardened and tempered, usually in an inductive manner and, as the final step, the said outer surface is polished to size and, if necessary, honed.

Further details and advantages of the invention proceed from the sub claims in conjunction with the description of an exemplary embodiment, which is explained in more detail by way of the drawings.

In which:

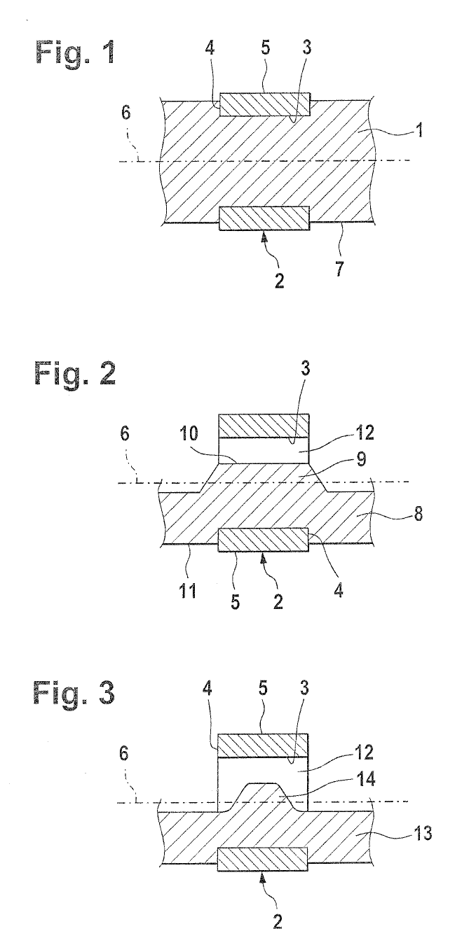

FIG. 1 is a sectional representation of a shaft with roller bearing according to the invention, an inner ring being embedded into the shaft in a circumferential manner;

FIG. 2 is a sectional representation of another development of the shaft with roller bearing according to the invention, where the inner ring is embedded into the shaft only partially in the radial direction and over its entire width in the axial direction;

FIG. 3 is a sectional representation of another development of the shaft with roller bearing according to the invention, where the inner ring is embedded into the shaft only in portions in the radial direction and in the axial direction;

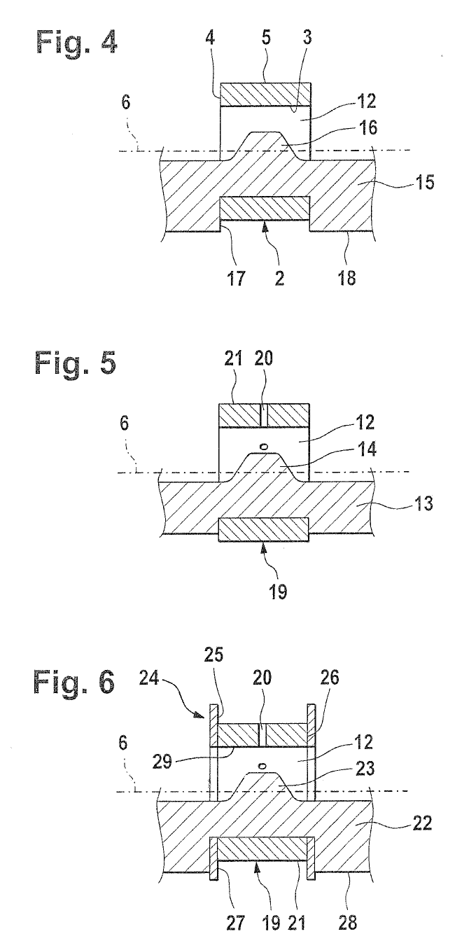

FIG. 4 is a sectional representation of another development of the shaft with roller bearing according to the invention, where the inner ring is embedded into the shaft only in portions in the radial direction and in the axial direction and the radial extension of the inner ring is smaller than the extension of the shaft;

FIG. 5 is a sectional representation of another development of the shaft with roller bearing according to the invention, where the inner ring is embedded into the shaft only in portions in the radial direction and in the axial direction and the inner ring has a radial bore;

FIG. 6 is a sectional representation of another development of the shaft with roller bearing according to the invention, where the inner ring is embedded into the shaft only in portions in the radial direction and in the axial direction, the inner ring has a radial bore and is provided with a thrust washer;

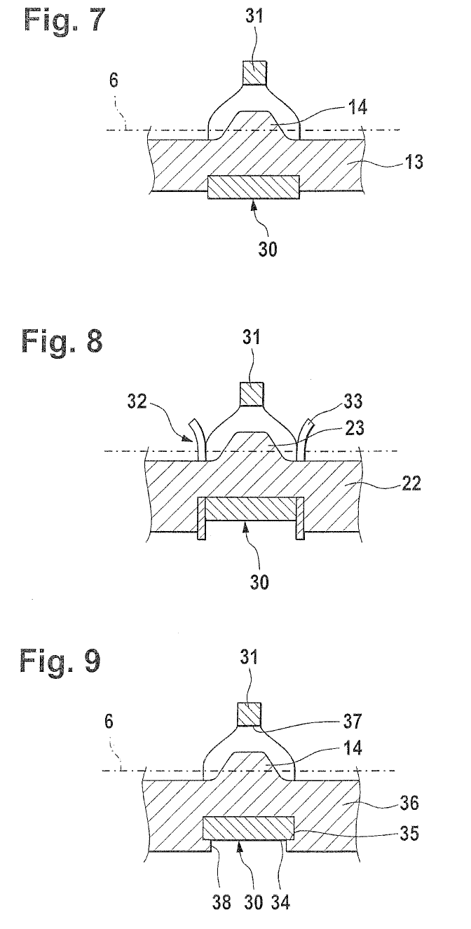

FIG. 7 is a sectional representation of another development of the shaft with roller bearing according to the invention, where the inner ring is embedded into the shaft only in portions in the radial direction and in the axial direction and the width of the inner ring changes along its circumference;

FIG. 8 is a sectional representation of another development of the shaft with roller bearing according to the invention, where the inner ring is embedded into the shaft only in portions in the radial direction and in the axial direction, the width of the inner ring changes along its circumference and the thrust washer is realized as a sector with insertion inclination; and

FIG. 9 is a sectional representation of another development of the shaft with roller bearing according to the invention, where the inner ring is embedded into the shaft only in portions in the radial direction and in the axial direction, the width of the inner ring changes along its circumference and the outer surface of the inner ring is partially embedded into the shaft.

It must be noted at this point that identical parts in the individual figures also have identical references.

FIG. 1 shows a shaft 1 constructed using primary forming techniques, said shaft having a surface 7, into which an inner ring 2 of a roller bearing is embedded. The inner ring 2 is produced from roller bearing steel. The inner ring 2 has an inner surface 3, two side surfaces 4 and an outer surface 5. The inner ring 2 is in the form of a rotationally symmetrical hollow cylinder with a central axis 6. The shaft 1 is also rotationally symmetrical. Both the central axis 6 of the inner ring 2 and the central axis of the shaft 1 are congruent. The embedding of the inner ring 2 is effected in such a manner that the inner surface 3 and a portion of the two side surfaces 4 are surrounded by the material of the shaft 1 in such a manner that each point on the outer surface 5 is further away radially from the central axis 6 than each point on the surface 7 of the shaft 1. In order to guarantee better positive locking of the inner ring to the shaft, the inner surface 3 and the side surfaces 4 are sand blasted or provided with a structure.

FIG. 2 shows a cast shaft 8, where the material is present essentially only on one side of the inner ring 2. In this case too, the embedding of the inner ring 2 into the shaft 8 is effected in such a manner that the inner surface 3 and a portion of the two side surfaces 4 are surrounded by the material of the shaft 8 such that each point on the outer surface 5 is further away radially from the central axis 6 than each point on the surface 11 of the shaft 8. However, the inner ring 2 is only embedded in a portion such that a hollow space 12 is produced between the shaft 8 and the inner ring 2. An elevation 9 is fixedly connected to the shaft 8, said elevation embedding the entire width 10 of the inner surface 3 of the inner ring 2 and a portion of the side surfaces 4. The elevation 9 in conjunction with the shaft 8 embeds the inner ring 2 in a sector that is greater than 180°. This guarantees a positive-locking, permanent connection between shaft 8 and inner ring 2.

The shaft 13 represented in FIG. 3 differs from the shaft represented in FIG. 2 in that the elevation 14 does not extend over the entire width of the inner ring 2 but rather along the inner surface 3 of the inner ring 2. The elevation 14 is consequently narrower than the inner ring 2 is wide. As the elevation 14 in conjunction with the shaft 13 also embeds the inner ring 2 in a sector larger than 180° at least in a portion, axial and radial securement of the inner ring 2 is guaranteed.

The shaft 15 represented in FIG. 4 differs from the shaft 13 represented in FIG. 3 in that the outer surface 5 of the inner ring 2 is offset in a portion in the radial direction relative to the outer surface 18 of the shaft 15. This results, on the one hand, in an increase in the imbalance of the shaft with reference to the axis of rotation 6. On the other hand, the flanks 17 created in this manner and extending flush with the side surfaces 4 of the inner ring 2, can be utilized to guide the rolling elements or the rolling element cage in the axial direction.

The inner ring 19 represented in FIG. 5 differs from the inner ring 2 represented in FIG. 3 in that the inner ring 19, in the region of the hollow space 12, has at least one bore 20 that is centrally disposed and extends in the radial direction. Said bore 20 is used in operation to move lubricant, more especially oil mist, by means of centrifugal force from the hollow space 12 to the rolling element cage or rolling element (not represented here) rolling on the outer surface 21.

FIG. 6 shows the inner ring 19 known from FIG. 5 with its bores 20. The outer surface 21 of the inner ring 19 is offset in the radial direction in a portion relative to the surface 28 of the shaft 22. A thrust washer 24 is situated flush with the inner ring 19 on each side of the inner ring 19 in such a manner that the inner surface 25 of the thrust washer 24 contacts the side surface 26 of the inner ring 19. In addition, the inside diameter of the thrust washer 24 is as large as the inside diameter of the inner ring 19. The central axis of the thrust washer 24 is also orientated relative to the central axis 6 of the inner ring 19 such that they are in alignment together. Said arrangement guarantees that the shaft does not become more constricted than as effected by means of the inner ring 19. On the side remote from the inner ring 19, the thrust washer 24 has an outer surface 27, which is connected to the material of the shaft 22. The shaft 22 embeds the entire width of an inner surface 29 of the inner ring 19. An elevation 23 is fixedly connected to the shaft 22, said elevation no longer extending over the entire width of the inner ring 2, but only in a portion along the inner surface 29. The elevation 23 in conjunction with the shaft 22 embeds the inner ring 19 in a sector that is greater than 180°. Additional structuring of the outer surface 27 of the thrust washer 24 provides a good positive-locking connection between the thrust washer 24 and the shaft 22. The thrust washers 24 provide axial guiding for the rolling element cage or the rolling elements.

FIG. 7 shows another development of the shaft 13 with inner ring 2 shown in FIG. 3. In this case, the width of the inner ring 30 extends constantly over a sector of 180° in the region that is embedded into the shaft 13 with its elevations 14, and is then continuously reduced by 90° to a web 31. In this case, the inner ring 30 is optimized to the forces working on it in operation. As the imbalance loads one side of the inner ring 30 more than the other, this can be used to adapt the load capacity of the inner ring 30 to the forces actually prevailing in operation.

FIG. 8 shows the inner ring 30 represented in FIG. 7 in conjunction with the shaft 22 shown in FIG. 6. The thrust washer 32, in this case, is in the form of a sector that is greater than 180°. The thrust washer 32 is positioned relative to the shaft 22 such as is described in FIG. 6. The sector edge regions of the thrust washer 32 that are not embedded into the shaft 22 are bent away from the inner ring 30 and serve as insertion inclination 33 for rolling elements or their rolling element cage (not shown in this case) and consequently as an axial guide. The rolling elements, in this exemplary embodiment, are guided by the thrust washers 32 in the region of the inner ring 30 at which the highest load occurs.

FIG. 9 shows the inner ring 30 represented in FIG. 7 in conjunction with a shaft 36 and the elevations 14 that are fixedly connected to said shaft and extend on the inside 37 of the inner ring 30. On its outer surface 34 to the sides, the inner ring has edge regions 35 that are surrounded by the material of the shaft 36.

The shaft is produced by the semifinished inner ring being inserted into the primary forming tool. The shaft is then prepared using sintering methods or casting methods. The outer surface of the inner ring is then machined, inductively hardened, tempered, polished and possibly honed.

A first machining of the inner ring embedded in the shaft may be necessary as the inner ring becomes deformed in certain circumstances through the heat created by the casting process, such that it would be too time-consuming and consequently too expensive to balance it out only by means of a grinding process.

An outer surface of the inner ring embedded in the shaft and produced in this manner can be used in an excellent manner as a bearing surface for a friction bearing.

It must also be pointed out that “one” or “a” does not exclude the plural. In addition, it must be pointed out that features or steps that have been described with reference to one of the above exemplary embodiments, can also be used in combination with other features or steps of other above described exemplary embodiments. References in the claims are not to be seen as restrictions.

1. A shaft with at least one roller bearing having an inner ring with an outer surface for rolling elements to roll on, wherein the inner ring of the roller bearing is embedded at least partially into the shaft, which has been produced using primary forming methods, and the outer surface of the inner ring is exposed at least in a portion in an axial direction and over an entire circumference of the outer surface.

2. The shaft according to claim 1, wherein the roller bearing includes a roller bearing cage, which is threaded over one end of the shaft over the inner ring.

3. The shaft according to claim 1, wherein the inner ring is embedded into the shaft in an angular range that is greater than 180°, but less than 360°.

4. The shaft according to claim 3, wherein a part region of the inner ring is embedded into the shaft over an entire width of an inner surface.

5. The shaft according to claim 1, wherein a part region of the outer surface of the inner ring is embedded into the shaft.

6. The shaft according to claim 1, wherein the roller bearing includes a thrust washer and a portion of the thrust washer is embedded into the shaft to a side of the inner ring.

7. The shaft according to claim 6, wherein the thrust washer is in the form of a sector, which encloses an angle that is greater than a load area of the roller bearing in a radial direction.

8. The shaft according to claim 7, wherein one of two end portions of the thrust washer produced by the sector shape is realized as insertion inclination.

9. The shaft according to claim 1, wherein inner surface and/or a side surface of the inner ring is structured.

10. The shaft according to claim 3, wherein the inner ring includes a passage.

11. The shaft according to claim 10, wherein the passage is in the form of radial bore.

12. The shaft according to claim 10, wherein the passage extends centrally in an axial direction in the inner ring.

13. The shaft according to claim 1, wherein the inner ring has a width and a circumference, and the width changes along the circumference.

14. The shaft according to claim 13, wherein the inner ring is in the form of an inner ring sector.

15. The shaft according to claim 14, wherein the inner ring sector encloses an angle that is greater than 180°.

16. The shaft according to claim 1, wherein the inner ring is produced from roller bearing steel.

17. The shaft according to claim 1, wherein the shaft is in the form of a balance shaft.

18. Use of the shaft according to claim 17, wherein the balance shaft can be used in a reciprocating piston engine.

19. A method for producing a shaft with roller bearing, wherein the roller bearing includes an inner ring with an outer surface, wherein the inner ring is inserted into a primary forming tool of the shaft that is to be produced by means of primary forming techniques in such a manner that the inner ring is at least partially embedded and the outer surface of the inner ring (2; 19; 30) is exposed in an axial direction in a portion and over an entire circumference of the outer surface.

20. The method according to claim 19 wherein the roller bearing also includes a thrust washer and a portion of the thrust washer is embedded into the shaft to a side of the inner ring.

21. The method for producing a shaft with roller bearing according to claim 19, wherein outside of the inner ring is machined, heat-treated and finished.
